(19) United States
(12) Patent Application Publication
(10) Pub. No.: US 2024/0054285 A1
(43) Pub. Date: Feb. 15, 2024

(54) SENTENCE PAIR RANKING IN NATURAL LANGUAGE PROCESSING FOR A VIRTUAL ASSISTANT

(71) Applicant: TOTVS, Inc., Raleigh, NC (US)

(72) Inventors: Felipe Barbosa MENDES, São Paulo (BR); Juvenal José DUARTE, São Paulo (BR); Jean Da Rolt JOAQUIM, Rio Grande do Sul (BR); Rafael RUI, London (GB); Vincent T. GOETTEN, Raleigh, NC (US)

(21) Appl. No.: 18/448,161

(22) Filed: Aug. 10, 2023

Related U.S. Application Data
(60) Provisional application No. 63/370,954, filed on Aug. 10, 2022.

(51) Int. Cl. G06F 40/205

(52) U.S. Cl. CPC G06F 40/205

(57) ABSTRACT

The present disclosure relates to computer-implemented methods, systems, and/or computer program products for training a machine learning model for sentence pair matching in natural language processing. For example, computer-implemented methods described herein can include preparing sentence pairs from a training dataset, where each sentence pair comprises a pairing of a search string and a target document from the training dataset. The computer-implemented method can also include ranking the sentence pairs based on an amount of similarity between the search string and the target document. Further, the computer-implemented method can include identifying an outmatched sentence pair. The target document of the outmatched sentence pair is a non-responsive document to the search string. The computer-implemented method can moreover include utilizing the outmatched sentence pair to tune a parameter of a natural language processing model to generate a trained model.

### RELATED APPLICATIONS

This application claims priority benefit of U.S. Provisional Patent Application Ser. No. 63/370,954 filed Aug. 10, 2022, titled “SENTENCE PAIR RANKING IN NATURAL LANGUAGE PROCESSING FOR A VIRTUAL ASSISTANT,” the complete disclosure of which, in its entirety, is herein incorporated by reference.

### TECHNICAL FIELD

The technical field relates to virtual assistants and machine learning using natural language processing.

### BACKGROUND

Virtual assistants have been utilized to address common questions or concerns posed by people via a user interface. For instance, virtual assistants can be implemented in connection with a chatbot system, designed to interact with one or more customers via an Internet connection. However, the accuracy of responses generated by the virtual assistant can be inhibited by challenges in assessing the user's question and/or investigating its semantic relation to documents on the knowledge databases from which an answer may be retrieved.

Pre-trained computer models can be utilized to rank documents in a knowledge database and facilitate one or more natural language processing (“NLP”) tasks that can assist the virtual assistant's operation. However, these models can fail when handling domain specific text. For that reason, a common approach is to fine tune the pre-trained model on the target task (e.g., task adaptation), with the examples of the target data (e.g., data domain adaptation). Yet, the process of adjusting the model is not an easy task. For example, depending on the methodology adopted, the fine tune process may lead to a “catastrophic forgetting”, meaning all knowledge from pre-training is lost during the fine tune weights adjustments. The resulting model not only doesn't learns where it fails, but also starts failing where previously performed well.

Apart from the NLP related challenges, regarding the implementations of a reusable architecture, which can be employed on different types of assistance, for example, answering Frequent Asked Questions (“FAQ”), recovering relevant documentation, finding pertinent fixes given a problem and so forth.

### SUMMARY OF THE DISCLOSURE

The present disclosure provides technical solutions to overcome the above problems. According to an embodiment consistent with the present disclosure, a computer-implemented method for training a machine learning model for sentence pair matching in natural language processing. The computer-implemented method can include preparing sentence pairs from a training dataset, where each sentence pair comprises a pairing of a search string and a target document from the training dataset. The computer-implemented method can also include ranking the sentence pairs based on an amount of similarity between the search string and the target document. Further, the computer-implemented method can include identifying an outmatched sentence pair. The target document of the outmatched sentence pair is a non-responsive document to the search string. The computer-implemented method can moreover include utilizing the outmatched sentence pair to tune a parameter of a natural language processing model to generate a trained model

In another embodiment, a chatbot system is provided. The system can include memory to store computer executable instructions. The system can also include one or more processors, operatively coupled to the memory, that execute the computer executable instructions to implement a virtual assistant that identifies content data from a knowledge database that is related to query based on a similarity score that characterizes a sentence pairing that includes text of the query and an article attribute, wherein the article attribute is at least one of a content attribute or a search attribute.

In a further embodiment, a computer program product for training a natural language processing model for searching a knowledge database for a response to a query is provided. The computer program product can include a computer readable storage medium having computer executable instructions embodied therewith. The computer executable instructions can be executable by one or more processors to cause the one or more processors to prepare sentence pairs from a training dataset, where each sentence pair comprises a pairing of a search string and a target document from the training dataset. Also, the computer executable instructions can cause the one or more processors to rank the sentence pairs based on an amount of similarity between the search string and the target document. Further, the computer executable instructions can cause the one or more processors to identify an outmatched sentence pair, wherein the target document of the outmatched sentence pair is a non-responsive document to the search string. Moreover, the computer executable instructions can cause the one or more processors to utilize the outmatched sentence pair to tune a parameter of a natural language processing model to generate a trained model.

This summary is not an extensive overview of the disclosure and is neither intended to identify certain elements of the disclosure, nor to delineate the scope thereof. Further embodiments, features, and advantages of the invention, as well as the structure and operation of the various embodiments of the invention are described in detail below with reference to accompanying drawings.

### BRIEF DESCRIPTION OF THE DRAWINGS

FIG. 1 illustrates a block diagram of an example, non-limiting system that can generate one or more responses to queries based on one or more databases and/or train one or more computer models in one or more NLP tasks in accordance with one or more embodiments described herein.

FIG. 2 illustrates a block diagram of example, non-limiting computer readable components that can be associated with a virtual assistant to generate one or more responses to queries based on one or more databases in accordance with one or more embodiments described herein.

FIGS. 3-9 illustrate diagrams of example, non-limiting portions of a user interface that can facilitate a virtual assistant to generate one or more responses to queries based on one or more databases in accordance with one or more embodiments described herein.

FIGS. 10-11 illustrate diagrams of example, non-limiting computer code and/or parameters that can facilitate a virtual assistant to generate one or more responses to queries based on one or more databases, in accordance with one or more embodiments described herein.

FIG. 12 illustrates a flow diagram of an example, non-limiting computer-implemented method that can be employed by a virtual assistant to generate one or more responses to queries based on one or more databases in accordance with one or more embodiments described herein.

FIGS. 13-17 illustrate diagrams of example, non-limiting portions of a user interface that can facilitate a virtual assistant to generate one or more responses to queries based on one or more databases in accordance with one or more embodiments described herein.

FIG. 18 illustrates a diagram of an example, non-limiting chatbot conversation flow that can be analyzed and/or generated by one or more virtual assistant components in accordance with one or more embodiments described herein.

FIG. 19 illustrates a diagram of example, non-limiting computer readable components that can be associate with a ranking component to rank one or more documents and/or train one or more NLP models in accordance with one or more embodiments described herein.

FIG. 20 illustrates an example of non-limiting computer-implemented methods that can be implemented on a model customization engine, in order to rank one or more documents and/or train one or more NLP models in accordance with one or more embodiments described herein.

FIG. 21 illustrates a diagram of an example, non-limiting table that can include one or more settings parameters that can be implemented by a ranking component to rank one or more documents and/or train one or more NLP models in accordance with one or more embodiments described herein.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

The present disclosure relates to virtual assistants and machine learning used in natural language processing as the mean of interaction between user and specialist systems. In embodiments, one or more virtual assistant operations can utilize sentence pair ranking to facilitate one or more natural language processing (“NLP”) tasks, and more specifically to, train one or more machine learning models using a sentence pair ranking scheme so as to search and/or curate a knowledge database employed by one or more virtual assistants.

### Terminology

As used herein, the term “model,” or grammatical variants thereof, can refer to one or more machine learning models.

As used herein, the term “machine learning” can refer to an application of artificial intelligence technologies to automatically and/or autonomously learn and/or improve from an experience (e.g., training data) without explicit programming of the lesson. For example, machine learning can utilize one or more computer algorithms to facilitate supervised and/or unsupervised learning to perform tasks such as: classification, regression, clustering, and/or natural language processing. Models can be trained on one or more training datasets in accordance with one or more model configuration settings.

Embodiments refer to illustrations described herein with reference to particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

In the detailed description of embodiments that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

One or more embodiments are now described with reference to the Drawings, where like referenced numerals are used to refer to like elements throughout. In the following detailed description of the embodiments, for purposed of explanation, numerous specific details are set forth in order to provide a more thorough understanding of the one or more embodiments. However, it is evident that one or more embodiments can be practiced without these specific details.

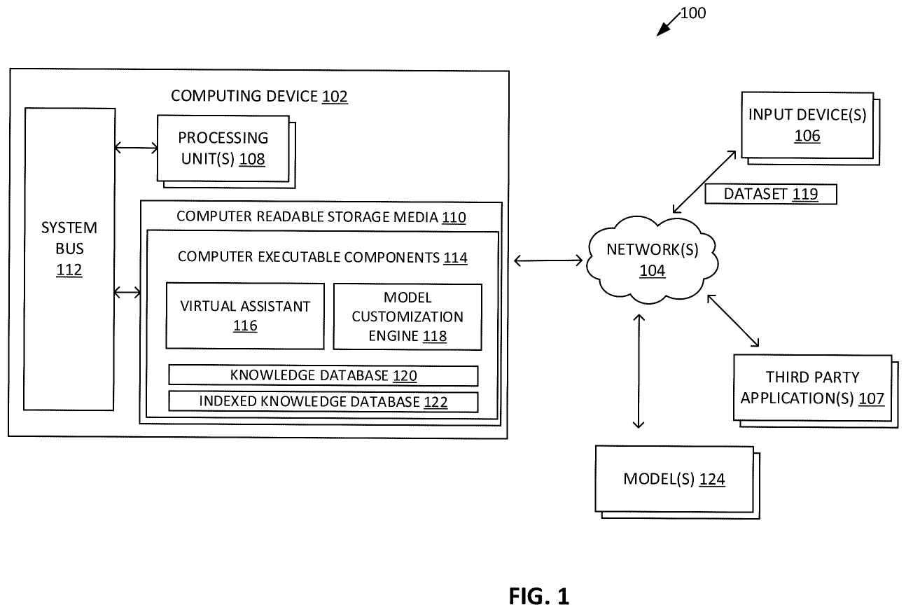

FIG. 1 illustrates a block diagram of an example, non-limiting system 100 that can facilitate one or more virtual assistant operations and/or NLP model training techniques. One or more aspects of system 100 can constitute one or more machine-executable components that can be embodied within one or more computer readable mediums associated with one or more machines. For example, one or more machines (e.g., computers, computing devices, virtual machines, and/or the like) can execute the one or more machine-executable components to perform various operations described herein.

As shown in FIG. 1, the system 100 (e.g., a chatbot system) can comprise one or more computing devices 102, networks 104, input devices 106, and/or third party applications 107. The one or more computing devices 102 can comprise one or more processing units 108 and/or computer readable storage media 110. In various embodiments, the one or more processing units 108 and computer readable storage media 110 can be operably coupled by one or more system buses 112. In various embodiments, the one or more computing devices 102 can be, for example: a server, a desktop computer, a laptop, a hand-held computing apparatus, a programmable apparatus, a minicomputer, a mainframe computer, an Internet of Things (“IoT”) device, a combination thereof, and/or the like.

In one or more embodiments, the computer readable storage media 110 can be distributed across a computing environment and remotely accessible (e.g., by the one or more processing units 108) via the one or more networks 104. The computer readable storage media 110 can comprise one or more memory units and can store one or more computer executable components 114, which can be executed by the one or more processing units 108. The one or more computer executable components 114 can comprise, for example, virtual assistant 116 and/or model customization engine 118.

In various embodiments, the one or more computer executable components 114 can be program instructions for carrying out one or more operations described herein. For example, the one or more computer executable components 114 can be, but are not limited to: assembler instructions, instruction-set architecture (“ISA”) instructions, machine instructions, machine dependent instructions, microcode, firmware instructions, state-setting data, configuration data, source code, object code, a combination thereof, and/or the like. For instance, the one or more computer executable components 114 can be written in one or more procedural programming languages. Although FIG. 1 depicts the computer executable components 114 stored on the computing device 102, the architecture of the system 100 is not so limited. For example, the one or more computer executable components 114 can be stored on one or more computer readable storage media 110 that are external to the computing device 102. In one or more embodiments, the one or more models 124 can be one or more computer models, such as pre-trained machine learning models (e.g., including natural language processing models, indexing models, deep neural network models, and/or the like).

In various embodiments, the virtual assistant 116 can respond to one or more queries (e.g., questions) submitted to the system 100 (e.g., via the one or more input devices 106, such as via a chatbot conversation). The virtual assistant 116 can respond to the one or more queries (e.g., answer one or more questions) based on, for example, one or more knowledge bases 120. In various embodiments, the one or more knowledge bases 120 can include, but are not limited to: a common questions database, a manuals database, an articles database, a database regarding one or more other sources of authority, a combination thereof, and/or the like. In one or more embodiments, the virtual assistant 116 can generate one or more responses by associating questions provided by a user with pre-established content. For instance, given a customer's question, check the common questions base to see if there is a corresponding answer to similar questions. In another instance, given a problem described by the user, it searches for articles, documents or sections of manuals that deal with the problem described, recommending the content with the greatest similarity to the search. To facilitate the understanding, the present disclosure adopts the article terminology for each of the documents. Each article can correspond to a unique row in the knowledge base, represented by a primary key.

Although the word “database” is used throughout this document, the data consumption may occur not only by a direct connection to a database, but also through an intermediate third party API connection, giving the chatbot configuration more flexibility.

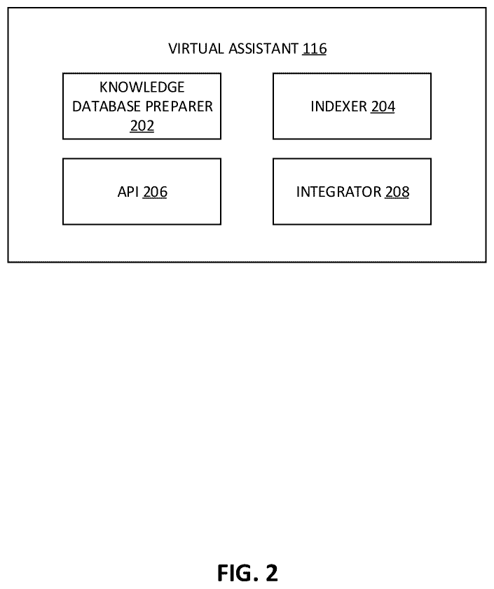

FIG. 2 illustrates a diagram of the example, non-limiting virtual assistant 116 comprising knowledge database preparer 202, indexer 204, API 206, and/or integrator 208 in accordance with one or more embodiments described herein.

In various embodiments, the knowledge database preparer 202 can standardized content from one or more datasets 119 to generate the one or more knowledge databases 120. For example, the knowledge database preparer 202 can generate knowledge databases 120 that characterize a dataset 119 with respect to one or more: identifiers, search attributes, filter attributes, content attributes, a combination thereof, and/or the like. For instance, the one or more knowledge databases 120 generated by the knowledge database preparer 202 can be embodied as a table, where each row of the table is associated with a respective article. Each article can be an answer to a user's question, derived from the one or more datasets 119. Additionally, each row can include one or more article identifiers, filter attributes, content attributes, and/or search attributes associated with the respective article. In various embodiments, the virtual assistant 116 can search a knowledge database 120 for the appropriate article that is responsive to a user's inquiry, where the search can be facilitated and/or guided by a comparison between content from the user's inquiry and one or more search attributes of the articles. For example, the knowledge database preparer 202 can extract content from one or more datasets 119 and generate one or more search attributes and/or filter attributes that characterize the content, whereby a search for content responsive to a user's inquiry can be based on the search and/or filter attributes.

In one or more embodiments, each row of the knowledge database 120 can be a respective article that may be responsive to a user's inquiry and/or problem statement submitted to the virtual assistant 116. For instance, the virtual assistant 116 can prompt the user to provide an inquiry in the form of a detailed description, or a concise description, of a question or problem. Further each article can be characterized by, for example: an identifier, one or more search attributes, one or more content attributes, and/or one or more filter attributes. In various embodiments, the knowledge database preparer 202 can generate each article based on the content of the one or more datasets 119. For example, the knowledge database preparer 202 can employ one or more data transformation techniques to format the article within the knowledge database preparer 202. As such, the article of the knowledge database 120 can be based on the content of the one or more datasets 119 while not necessarily being identical to the content of the one or more datasets 119.

The article identifier can be a unique identifier associated with a respective article, such as a unique numerical identifier and/or name. The one or more search attributes can include text content that can be compared to the text of the user's question and/or problem statement. For example, the one or more search attributes can include question attributes, such as language that may be included in a user's question, to which the article is responsive. In another example, the one or more search attributes can include one or more tag attributes (e.g., specific words, terms, or phrases) that may be included in a user's problem statement, to which the article is responsive. For instance, the one or more search attributes can include one or more key words and/or terminology that can be compared to a user's inquiry. The one or more search attributes can be simple text and/or labels. In various embodiments, the one or more search attributes can be extracted from the one or more datasets 119 and/or can be generated using the data transformation techniques described herein. For example, the knowledge database preparer 202 can generate the one or more search attributes such that text and/or detail of the search attributes is predicted to be similar to that of a user's search inquiry.

In various embodiments, the one or more question attributes can be crafted so as to reduce the redundancy of articles. For instance, the question attribute can summarize a comprehensive scope of user questions associated with the content attribute. Where the content attribute may be responsive to multiple variations of a user's question, the knowledge database preparer 202 can generate a question attribute that encompasses the plurality of variations. Examples of a poorly crafted question attributes can be “how to include new employees” and/or “adding new collaborators;” whereas an example of a well-crafted question attribute for the same content attribute can be “inclusion of employees.” Additionally, the knowledge database preparer 202 can generate search attributes (e.g., question attributes) that are closely correlated to the content attribute, and constitute assertive descriptions of the content characterized by the content attribute. For instance, poorly crafted question attributes can include those addressing a general topic, rather than a specific subject addressed by the content attribute. An example of a poorly crafted question attribute that is an over generalization of a content attribute can be the question attribute “question about refrigeration,” where the content attribute is “the shelf life of dairy products is 30 days for closed and refrigerated packages, 1 day for open packages.” An example of a well-crafted question attribute for the same content attribute can be “shelf life of dairy products.” In said example, the specific subject addressed by the content attribute is the shelf life of dairy products, while a general topic associated with the content attribute may be refrigeration. In various embodiments, the knowledge database preparer 202 can generate specified search attributes based on one or more keywords from the content attribute (e.g., employing one or more natural language processing techniques).

To ensure that the semantics of the content attributes are properly characterized, respective tag attributes can be generated to address specific subjects. For instance, an example of a multi-subject tag attribute can be “software installation, configuration, and removal,” which characterizes multiple subjects regarding software initiation and/or modification. Examples of single subject tag attributes can include “software installation,” “software configuration,” and “software removal,” where a respective article is generated by the knowledge database preparer 202 for each respective search attribute. In various embodiments, the more generic the tag attributes of the articles are, the lower the likelihood of an identified article (and thereby an identified content attribute) being responsive to the user's inquiry. In one or more embodiments, articles can be characterized by a plurality of single subject tag attributes (e.g., where the associated content attribute may response to multiple subjects, and/or where a single subject can be described by one or more tag attribute variations). For example, the tag attributes can provide an assertive description of the associated content attribute of the given article. Where the content attribute may be responsive to one or more specific subjects, one or more tag attributes can include related keywords (e.g., related to one or more words of the content attribute), alternate keywords (e.g., synonyms to one or more words of the content attribute), hashtags, a combination thereof, and/or the like to characterize the given article. Thereby, the tag attributes can enable slightly different search inquires to lead to the same responsive article. For example, tag attributes such as “balance sheet closing,” and/or “calculation of federal taxes,” can be examples of tag attributes generated by the knowledge database preparer 202 to characterize the content attribute, “the closing of the balance sheet takes place in November and December, followed by the calculation of federal taxes during the month of January.”

In various embodiments, the tag attributes can enhance the accuracy of the search by the virtual assistant 116 for responsive articles in the knowledge database 120. For example, the tag attributes can enable the same article to be labeled in different ways, allowing different searches to point to the same result. However, that the more generic the tag attributes, the more results will be associated with the given search; which may degrade the user experience. In one or more embodiments the knowledge database preparer 202 can generate tag attributes particular to an article's content, where a given tag attribute is not shared by more than 5% of the articles of the knowledge database 120 as a whole.

The one or more filter attributes can be one or more criteria employed by the user and/or virtual assistant 116 to filter search results of responsive articles. For example, the one or more filter attributes can characterized a defined context for the one or more search attributes. For instance, the same question or problem statement may have different responsive content depending on the context of the inquiry, and the context can be characterized by the selection of one or more filter criteria. The more comprehensive the search space, the greater the chance the virtual assistant 116 may fail to identify the most suitable content in response to the user's inquiry. In various embodiments, the knowledge database preparer 202 can define the one or more filter attributes to provide a means to delimit the articles to be search by providing a context for the expected responses.

The one or more content attributes can be content responsive to the user's question and/or problem statement. For example, the content attribute can serve as an answer to a question and/or the solution to a problem. In various embodiments, the content attribute can be a defined text and/or script that can be presented to the user in response to the user's inquiry. In one or more embodiments, the one or more content attributes can be extracted from the one or more datasets 119 and/or can be generated from the one or more datasets 119 using the data transformation techniques described herein.

In various embodiments, each article can include a single content attribute to avoid excessive search results. The knowledge database preparer 202 can generate the articles to be short and/or concise. Further, the knowledge database preparer 202 can generate the articles so as to: reduce duplicity of articles within the knowledge database 120, avoid ambiguity, and/or improve coherence between search fields and content.

Table 1, presented below, is an example of a knowledge database 120 that includes multiple articles (e.g., ID 100, 200, and 300) that can be generated by the knowledge database preparer 202.

TABLE 1

| ID | Question | Response | Department | Tags |
|---|---|---|---|---|
| 100 | Update address | Visit the HR department with | Human | data update |
| | information | the necessary documents | Resources | |
| | | | (HR) | |
| 200 | Update a | Changing passwords can be | Systems | password change, |
| | password | done through the following | | expired password |
| | | link <link> | | |
| 300 | Badge blocked | Contact the following email, | Property | turnstile problems, |
| | | abc@defg.com. It can take up | administration | unauthorized access |
| | | to 3 days to unlock a badge. | | |

As shown in Table 1, “ID” can represent an article identifier, where each article (e.g., each row) is associated with a unique identifier (e.g., the article of the first row is represented by ID 100). “Question” can represent one of the search attributes (e.g., a question attribute) associated with the given article. “Response” can represent the content attribute associated with the given article (e.g., the text of the content attribute can be the response presented to a user engaging the virtual assistant 116 in reply to the user's question and/or problem statement). “Department” can represent the search attribute associated with the given article (e.g., the search for responsive articles to the user's inquire can be filtered via one or more criteria, such as a corporate department defined by the user while initializing the inquiry). “Tags” can represent one or more additional search attributes (e.g., tag attributes) associated with the given article (e.g., the content of the one or more tag attributes can further characterize the content attribute of the given article in accordance with various embodiments described herein). While Table 1 depicts articles related to inquiries that an employee may have about a company and/or work functions, the embodiments described herein are not limited to the exemplary use case of Table 1. Rather, the various features described herein are readily applicable to knowledge databases 120 regarding a wide variety of topics and/or subject matters.

In various embodiments, the indexer 204 can utilize a semantic indexing model (e.g., from the one or more models 124) to index the one or more knowledge databases 120. For example, the indexer 204 can index the knowledge databases 120 by executing a batch application that can: read the articles already arranged in a staging, treat the article attributes, and/or calculate the representation of each article in a semantic space. In various embodiments, one or more users can configure the performance of the indexer 204 via one or more settings pages that can be presented via the one or more input devices 106.

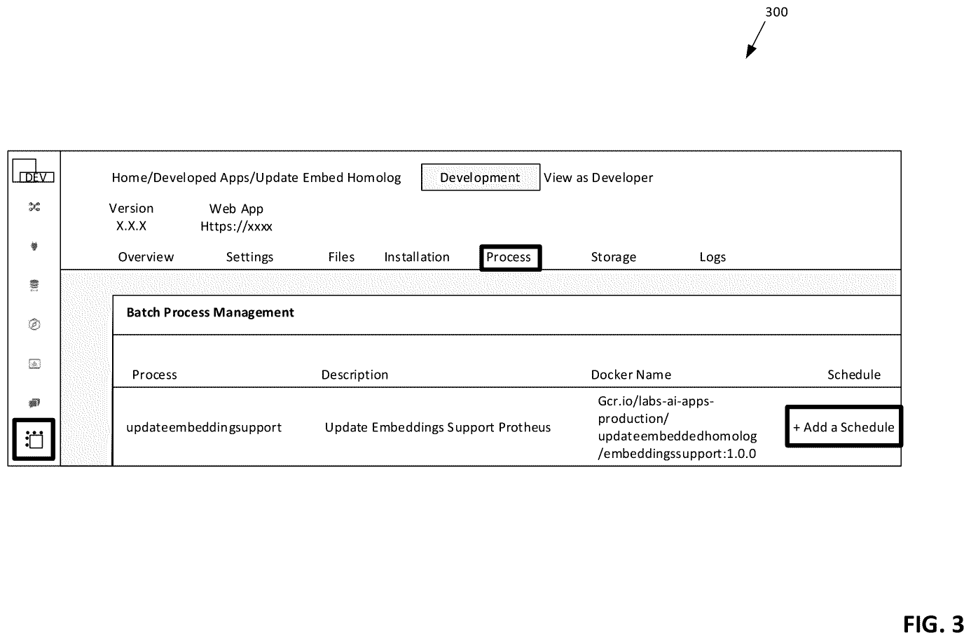

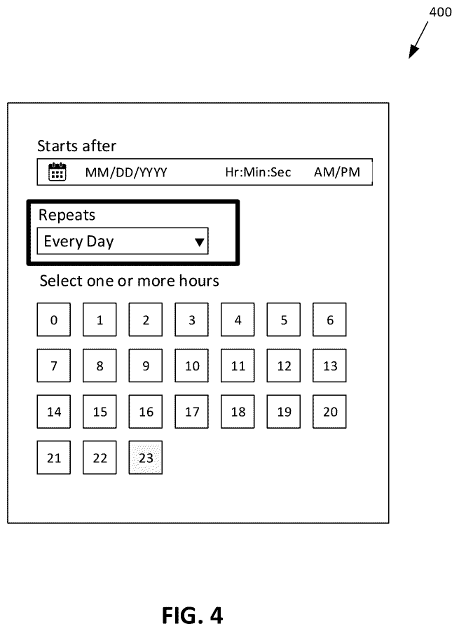

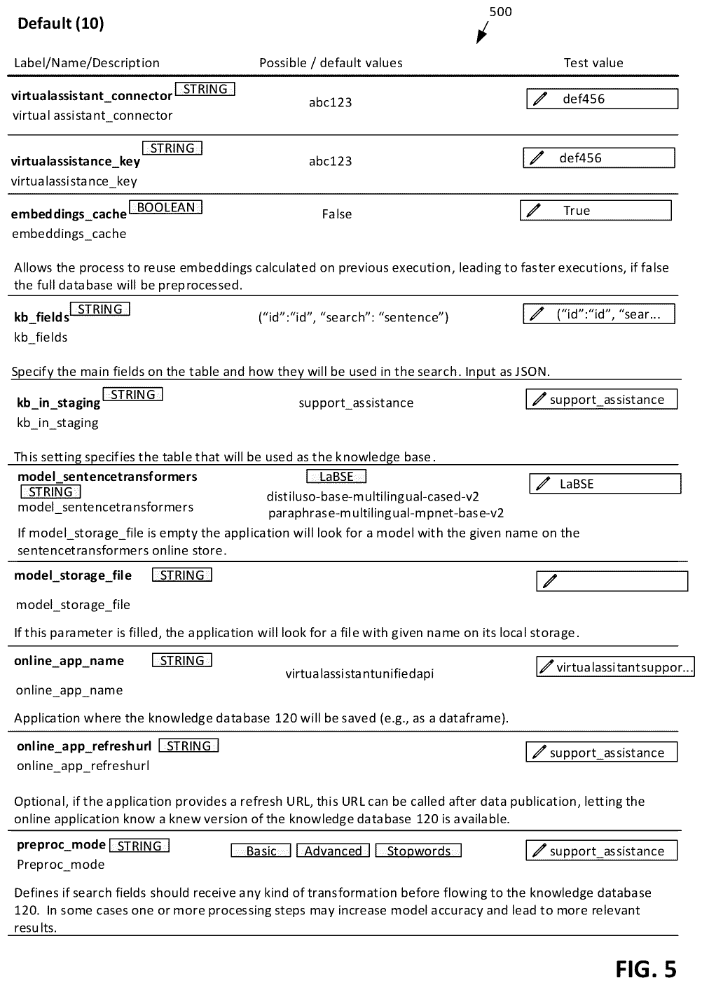

For example, FIGS. 3-5 depict example settings pages 300, 400, 500 that can be presented to the user (e.g., via the one or more input devices 106) to define various settings, such as processing schedules and/or parameter values. FIGS. 3-5 illustrate diagrams of example, non-limiting user interfaces that can facilitate various operations of the virtual assistant 116 in accordance with one or more embodiments described herein. In one or more embodiments, the one or more user interfaces shown in FIGS. 3-5 can be generated by the computing device 102 and presented via the one or more input devices 106. For instance, FIGS. 3 and/or 4 depict example user interfaces that can employed to configure a schedule for one or more indexing operations performed by the indexer 204. As shown in FIG. 3, a user can select an indexing batch application for scheduled processing. As shown in FIG. 4, the user can select the execution frequency in the “Repeats” option and choose the execution time/schedule. Further, FIG. 5 depicts an example user interface that can be employed to configure one or more parameters (e.g., ten example parameters) that collectively configure the one or more indexing operations performed by the indexer 204. The settings pages 300, 400, 500 can provide a mechanism to pass parameters to the indexer 204 so that basic configurations can become malleable to meet user preferences. In various embodiments, reading data from other tenants and/or organizations can be conditioned on the execution of user permissions.

In one or more embodiments, the example user interfaces can include feature descriptions to assist the user in defining the indexing configuration. For example, FIG. 5 includes a feature description for a plurality of the default parameters. While FIGS. 3-5 depict example user interfaces related to the indexing of the knowledge databases 120, the embodiments described herein are not limited to the exemplary layout and/or parameters shown in FIGS. 3-5. Rather, the various features described herein are readily applicable to alternate user interface layouts and/or indexing configuration parameters.

As shown in FIG. 5, the article attributes can be defined via the settings page 500 and passed to the knowledge database preparer 202 in, for example, JSON format by setting the “kb_fields.” For example, with respect to the article attributes of Table 1, each attribute can be set in accordance with the following:

```
{“id”:“ID”)
  “search”: “Question”,
  “tags”: “Tags”;
  “content”: “Response”;
  “filter”: “Department”}
```

From the “preproc_mode” parameter, it is possible for a user to define how the data will be processed to build the knowledge database 120. In various embodiments, multiple kinds of modes can define the preproc_mode parameter. For example, “Basic” mode can ensure that at least the encodings of the textual content will be standardized, avoiding unreadable characters. In another example, “Advanced” mode can enable, in addition to standardizing encodings, the removal of special characterizes and the standardization of all words in lower case, while also removing link words (e.g., which can be referred to as “stopwords”). This parameter can also be available for query transformations when interfacing with the user via the one or more input devices 106 (e.g., over an online computer application). In various embodiments, the preproc_mode parameter can embody the same setting for both processing a user's inquiry and for batch processing the one or more knowledge databases 120 (e.g., inconsistencies between how the inquiry and knowledge database 120 are processed can result in difficulties to identify responsive articles to user inquiries).

Depending on the size of the knowledge database 120 to be searched, performing the indexing operation can be time-consuming and computationally intensive. Setting the “embeddings cache” parameter can enable the indexer 204 to reuse calculations from the previous run to speed up processing. This configuration is indicated in situations where the knowledge database 120 undergoes few updates between executions, with few changes (e.g., with any changes largely limited to the search attributes). If the semantic indexing model employed by the indexer 204 is changed, this option must be disabled during the first run.

The last two parameters shown in FIG. 5 can be related to a natural language processing (“NLP”) semantic model employed by the virtual assistant 116. For example, where the “model_sentencetransformers” parameter is defined, the virtual assistant 116 can employ a standard NLP model (e.g., from the one or more models 124), which can be made available from a list of pre-evaluated models. In another example, where the “model_storage_file” parameter is defined, the virtual assistant 116 can load a customized model (e.g., from the one or more models 124) to address the user's inquiry. In one or more embodiments, a customized model can be employed for particular cases of high complexity and large volume knowledge databases 120, which can require one or more fine tuning operations with domain data.

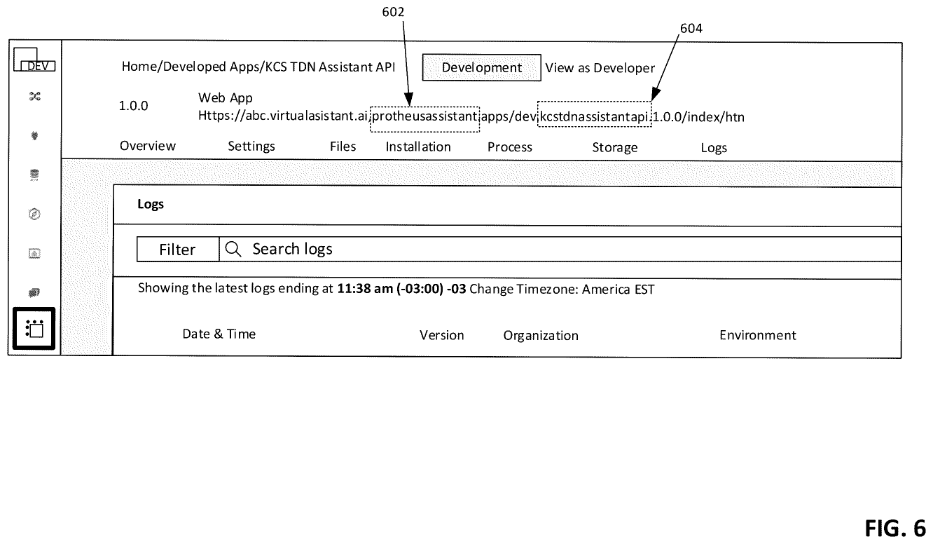

In various embodiments, the API 206 can be an online application having the characteristic of being continuously, or nearly continuously, available through an endpoint, composed, for example, as:
https://<tenant>-<app id>.apps.virtualassistant.ai/
   Where the “<tenant>” tag can be replaced by the id of the environment where the API 206 was published, while the “<app id>” tag can be replaced by the id of the executed application. In one or more examples, the <tenant> and/or <app id> can be found on one or more user interfaces of the one or more input devices 106 (e.g., depicted in FIG. 6). As shown in FIG. 6, it is possible to select one or more applications from a plurality of applications available in the tenant. For example, dotted box 602 delineates an example tenant name, and dotted box 604 delineates an example application name. Once the desired application is selected, the application URL shows the tenant name and the application id in its composition.

In one or more embodiments, the API 206 can operate in one of two different modes: a semantic only mode, or a hybrid mode. In the hybrid mode, both semantic (e.g., via a deep learning model 124) and keyword matching searches are combined to boost the performant of article ranking. Various operations of the API 206 can include one or more of the following. A first operation (e.g., a “query” operation) can include an address that receives POST requests with searches and returns the search results (e.g., both the request and the search results can be transmitted in JSON format). For example, API 206 calls can be made through POST requests to the endpoint of the online application. For instance, an example “curl” command is presented below with regards to the example knowledge database 120 of Table 1 to illustrate features of the query operation.

```
curl -X POST “https://tenant_id-app_id.apps.virtualassistant.ai/query”
  -H “Content-Type: application/json”
  -d‘{“query”:“search text”,“k”:“5”,
    “threshold_custom”:{“tags”: “80”},
      “filters”:[{“filter_field”: “department”,
      “filter_value”: “Human Resources”}]}’
```

In the above example, “query” can be a required attribute that contains the search to be performed on the knowledge database 120. “K” can be an optional attribute that defines the number of results to be returned. For example, three responses (e.g., content attributes) can be returned when k=3, where the three responses include content attributes with the greatest similarity to the search. “Threshold” can be an optional attribute that stipulates the minimum acceptable similarity score in the given search (e.g., where the similarity score can range between 0 and 1, with 1 representing the highest similarity). “Threshold_custom” can be an optional attribute that works similar to the threshold attribute but can be set a defined. For instance, in the example curl command shown above, {“tags”: “80”} can indicate that a minimum similarity score characterizing an 80% match with the tag attributes is defined. The “threshold” and “threshold_custom” values can be analyzed on a per-article basis. For example, these values can be closely related to the similarity between the user's inquiry and the indexed attributes (e.g., similarity between the user's question and/or problem statement and the article attributes of the knowledge database 120). In the example above, where the inquiry and article attributes are very similar, an 80% threshold can be enough to capture relevant (e.g., responsive) search results without adding unrelated content. Where the inquiry and article attributes are more distinct (e.g., such as distinct sentence lengths), a threshold of 60% or less may be utilized.

“Filters” can be an optional attribute that describes the scope of the search. For instance, in the example curl command shown above, “filters”:[{“filter_field”: “department”, “filter_value”: “Human Resources”}]” can indicate that the “department” field is utilized as the filter attribute and that only articles associated with the “Human Resources” department are to be considered in the search. Additionally, with reference to example Table 1, a “response_columns” attribute can be utilized that defines which knowledge database 120 columns should be returned by the search. By default the search can return the content attributes defined by the indexer 204. In one or more embodiments, additional columns (e.g., additional article attributes) can be returned to facilitate one or more validation operations.

A second operation (e.g., an “update_embeddings” operation) can refresh the one or more knowledge databases 120 (e.g., by reloading the data from disk to the online application's memory). This functionality can be executed each time a new knowledge database 120 indexing is performed (e.g., by the indexer 204 serving as a batch processing application). A third operation (e.g., a “load_model” operation) can be used when launching the application or updating a similarity model (e.g., from the one or more models 124). In one or more embodiments, each similarity model update can be synchronized between the indexer 204 and the API 206, otherwise the sematic representations of the knowledge database 120 and searches can be inconsistent. A fourth operation (e.g., “switch_keywordsearch” operation) can be employed where search attributes have more words than user searches and can include checking whether the search words from the user inquiry can match to one or more substrings of the search attributes (e.g., serving as a keyword search). A fifth operation (e.g., “validate” operation) can validate operations of the virtual assistant's 116 search of the knowledge database 120. For example, a test inquiry can be employed, where the responsive article from the knowledge database 120 is known. Where the known responsive article is not identified from the search, the API 206 can generate one or more notifications and/or perform one or more checks to investigate whether the indexing attributes employed by the indexer 204 are adequate.

In various embodiments, the API 206 response can also be made via JSON. An example result with reference to example Table 1 is presented below.

```
{“topk_results”:[
  {“ID”:100,
    “Response”:“Visit the HR department with the necessary documents”,
    “score”:0.5665125846862793,
}
],
“total_matches”:1
}
```

As shown in the example above, the API 206 response can be composed of two primary pieces of information: “topk_results” (e.g., which can represent a list of the top matching articles and/or content attributes) and “total_matches” (e.g., which can be a scalar metric that represents the total number of articles that may be responsive to the user inquiry). For instance, the topk_results can gather data from the k most responsive (e.g., most related to the user inquiry) articles in, for example, a list format. In another instance, the total_matches value can indicate the amount of articles found by the search generated in response to the user inquiry.

As shown in the example above, for each of the top matching articles (e.g., articles most relevant and/or responsive to the user's inquiry), the API 206 response can include the article identifier (e.g., “ID”), the content attribute (e.g., “Response”:“Visit the HR department with the necessary documents”) and/or the similarity score (e.g., “score”). In various embodiments, additional information of the article attributes can be added during the query operation via the “response_colums” parameter, including internal search attributes, such as: an indication as to which text of the content attribute is most relevant to match with the search (e.g., represented as “sentence” in the example below), and indication as to which article attribute the sentence text was found (e.g., represented as “sentence_source” in the example below), and/or an indication of whether the match occurred by semantics or by a keyword (e.g., represented as “type_of_search” in the example below).

Below is an example result of the same search, but passing the parameter: “response_columns”: [“ID”, “Response”, “Department”, “sentence”, “sentence_source”, “type_of_search”, “score”].

{“topk_results”:[
{“ID”:100,
“Response”:“Visit the HR department with the necessary documents”,
“Department”:“Human Resources”,
“sentence”:“data update”,
“sentence_source”:“Question”,
“type_of_search”:“Semantic”,
“score”:0.7265125846862793,
}
],
“total_matches”:1
}

In various embodiments, the API 206 can utilize one or more validation operations to curate one or more of the knowledge databases 120. For example, a knowledge database 120 may not initially be sufficiently adapted to facilitate the automated searches de scribed herein. Curation aims to identify cases where the user's inquiry is not answered satisfactorily, and adjusting the knowledge database 120 and/or the indexed knowledge database 122 so that its indexed fields (e.g., article fields) can be more aligned with the format and/or content of the user's question or problem statement. For example, the API 206 can provide the validation route, where once the expected article is known not to be returned by the search, the similarity between the indexed attributes and the user's inquiry can be analyzed. Below is an example of an API 206 call and corresponding output, with reference to Table 1, that can be implemented to facilitate the validation operation (e.g., can facilitate curating the knowledge database 120).

```
Call:
  curl -X POST
  “https://tenant_id-app_id.apps.virtualassistant.ai/validate”
  -H “Content-Type: application/json”
  -d‘{“query”:“search text”,“k”:“5”,
  “expected_ids”:[“100”]}’
Output
  {“topk_results”:[
  {“ID”:100,
  “sentence”:“update address information”,
  “sentence_source”:“Question”,
  “type_of_search”:“Semantic”,
  “score”:0.7265125846862793,
  },
  {“ID”:100,
  “sentence”:“data update”,
  “sentence_source”:“Tags”,
  “type_of_search”:“Semantic”,
  “score”:0.5365325844861113,
  },
  ],
  “total_matches”:2
  }
```

As output, each of the searchable attributes can be converted into indexing vectors following the same approach adopted with the knowledge database 120 (e.g., via the indexer 204). Additionally, keyword attributes can be generated such that there is one search sentence per keyword. The example above references Table 1, where the first article (e.g., ID 100) constitutes the expected result of a test search to check the how well the knowledge database 120 is adapted to user inquiries (e.g., as indicated by “expected_ids”:[“100”]). The first article (e.g., ID 100) has the searchable sentence “update address information” originating from the question attribute, and can reach a similarity score (e.g., in relation to the user inquiry) of 0.73 (e.g., 73%) via semantics. The first article (e.g., ID 100) also has the searchable sentence “data update” originating from the tag attribute, and can reach a lower similarity score (e.g., in relation to the user inquiry) of 0.53 (e.g., 53%). Thus, in the above example, an acceptable balance can be achieved between the user inquiry and the indexed sentences (e.g., characterized by the search attributes). Where the one or more similarity scores fall below a defined threshold for an article expected to be responsive, the search attributes can be adapted (e.g., via the knowledge database preparer 202 and/or the indexer 204) to increase correlation and/or similarity to the test inquiry (e.g., the question attribute and/or the tag attribute can be altered to characterize the content attribute in a different manner).

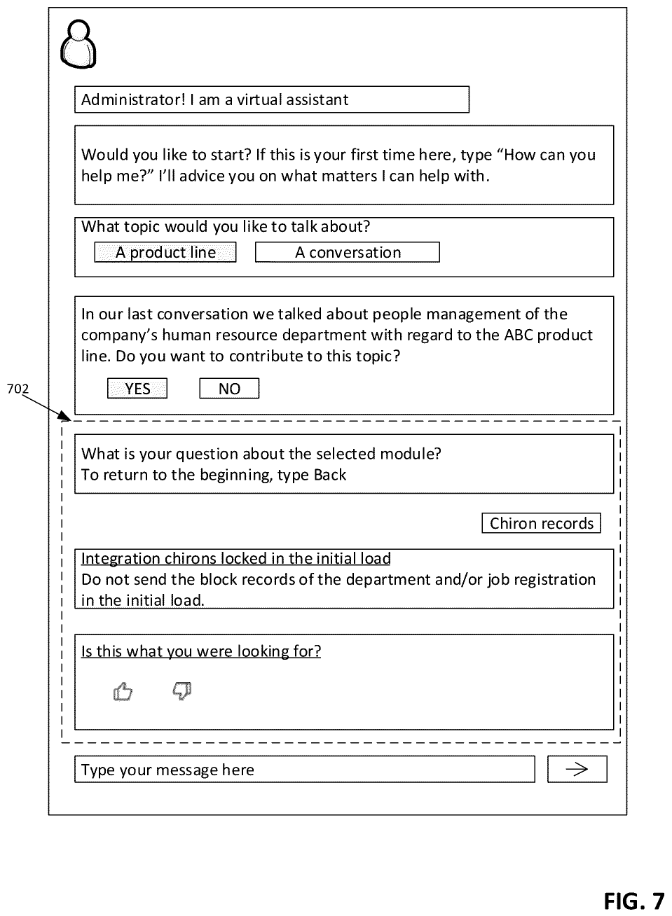

In various embodiments, the integrator 208 can integrate content from the one or more knowledge databases 120 into virtual assistant 116 conversations with the user (e.g., via the one or more input devices 106) to: suggest solutions that are responsive to user reported problems; and/or guide the construction of user inquiries. Conversations between the virtual assistant 116 and the user can be characterized by a conversation flow, which can include analyzing user intent and mapping the user intent to a relevant response. FIG. 7 illustrates an example conversation between the virtual assistant 116 and a user, where the user intent can be derived to help guide the construction of the user's inquiry. As described herein, the user intent and corresponding response mapping can be performed through computer codification (e.g., where logic programming is too complex). Further the virtual assistant 116 can allow for a set of pre-defined logic protocols for message processing, such as providing options for choice and simple text responses.

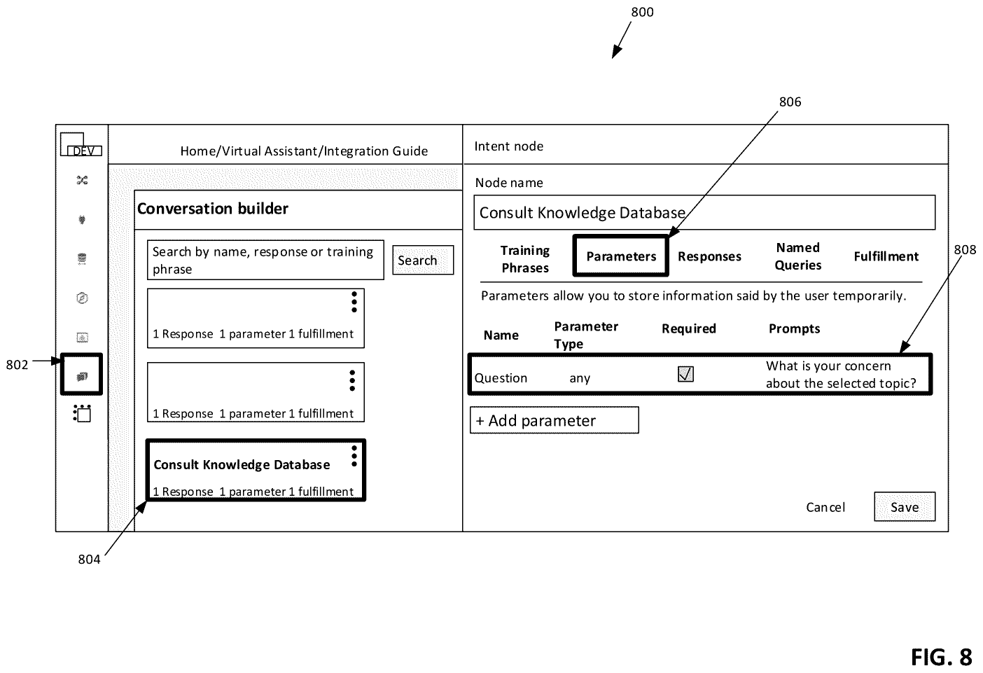

For example, the integrator 208 can initiate the search of a knowledge database 120 by first capturing the user's intention via the conversation workflow. For instance, as depicted in FIG. 7, the virtual assistant 116 can prompt the user to choose one or more predefined selections, which can correlate to, for example, one or more question attributes. In various embodiments, a developer can configure the conversation node of a conversation flow. For example, the virtual assistant can present one or more user interfaces on the one or more input devices 106 to enable customization of one or more conversation configuration settings, such as the example user interface 800 shown in FIG. 8. For instance, with respect to the example user interface 800, the developer can select the assistant icon 802 on the left side of the option menu. Then the developer can select a conversation flow 804 where they want to implement the knowledge database 120 inquiry, and select the “Parameters” tab in the displayed pop-up 806 to add one or more new parameters 908 (e.g., as shown in FIG. 8).

As shown in FIG. 8, various conversation nodes can be configured via the user interface of the one or more input devices 106 and/or can represent respective paths that the conversations may follow depending on the history of interactions along with the current parameters. Each of these nodes may include several configurations, including a fulfillment functionality.

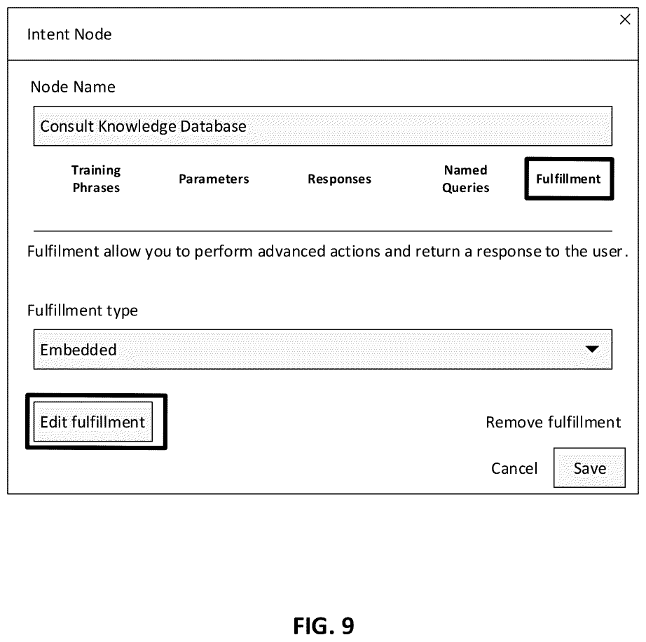

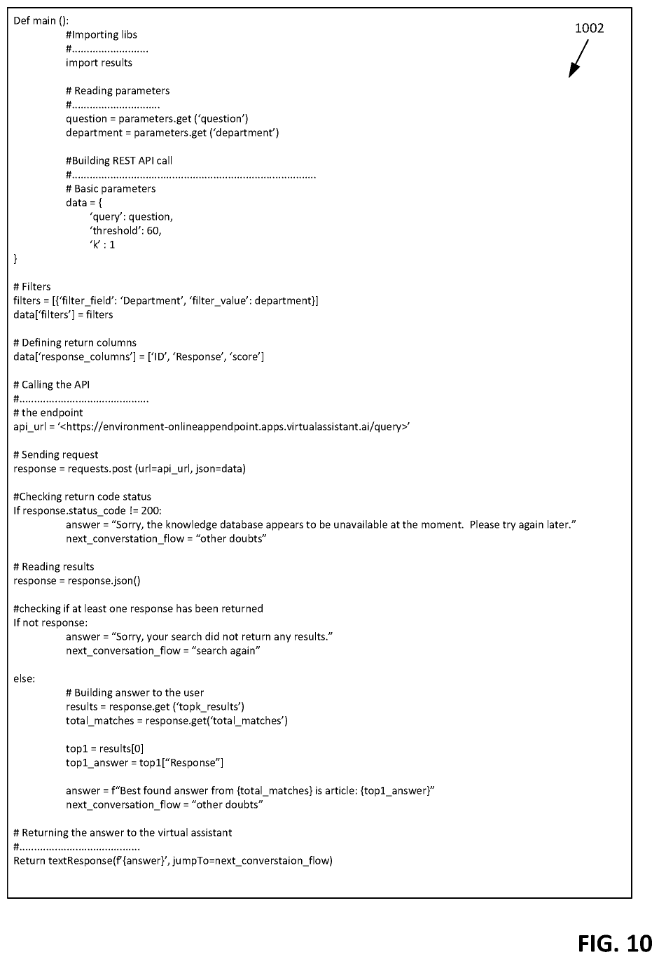

In various embodiments, the system 100 can allow for the handling of messages from users in a customized way through fulfillment functionality that can be implemented via the integrator 208. In various embodiments, the fulfillment functionality can be an intelligent layer of the integrator 208 that can collect information from the current conversation with the user, pass the collected information to fulfillment computer code, and present the results from fulfillment code in the conversation presented on the user interface. In various embodiments, customized fulfillment code can be added to the fulfillment functionality. For instance, with regard to the example user interface 900 shown in FIG. 9, to add a customized application, a user can select a fulfillment tab, click the “Edit fulfillment” option. In various embodiments, the fulfillment code can delineate standardized responses to various search result events. FIG. 10 provides an example of fulfillment code that can be utilized by the virtual assistant 116 for handling knowledge database 120 queries.

As shown in FIG. 10, the example fulfillment code 1002 can include four main parts. A first part (e.g., “#Reading parameters”) can be provided for reading one or more parameters provided in the conversation stream (e.g., the conversation between the virtual assistant 116 and the user). For instance, the virtual assistant 116 can prompt the user to select between one or more provided question attributes (e.g., as exemplified in FIG. 7). Similarly, the virtual assistant 116 can prompt the user to select between one or more provided filter attributes to facilitate a filtered search of the one or more knowledge databases 120.

A second part (e.g., “#Building REST API call”) of the example fulfillment code 1002 can be for adjusting API 206 call parameters in accordance with the various embodiments described herein. A third part of the example fulfillment code 1002 can be for submitting the request to the online application of the virtual assistant 116 (e.g., via indexer 204) and/or handling the results. Additionally, fourth part of the example fulfillment code 1002 can be for returning results to be presented to the user via the conversation flow.

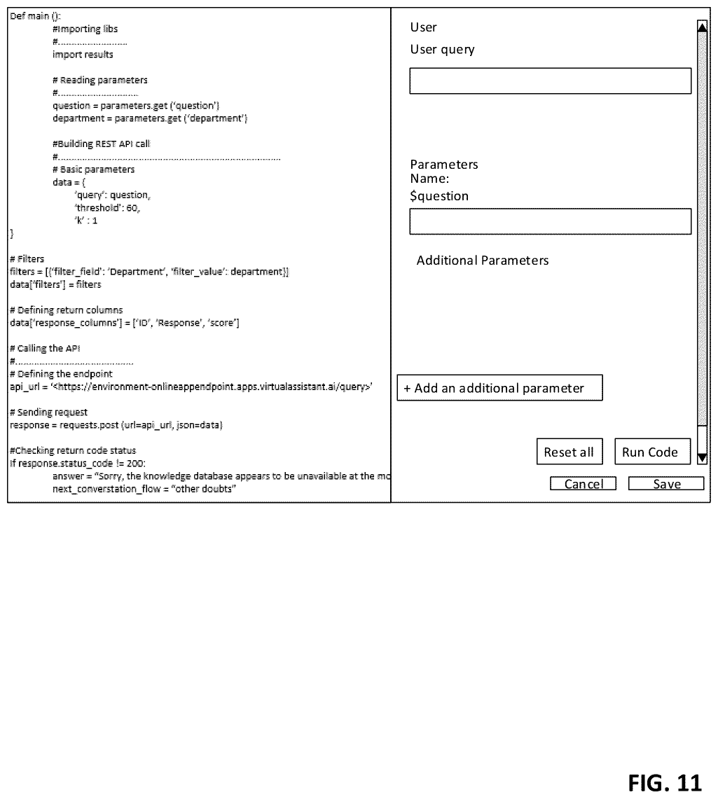

Once the fulfillment code with the desired treatment is defined, the fulfillment code can be registered in the text editor, tests can be run, and the code can be saved if the tests are satisfactory, as shown in FIG. 11.

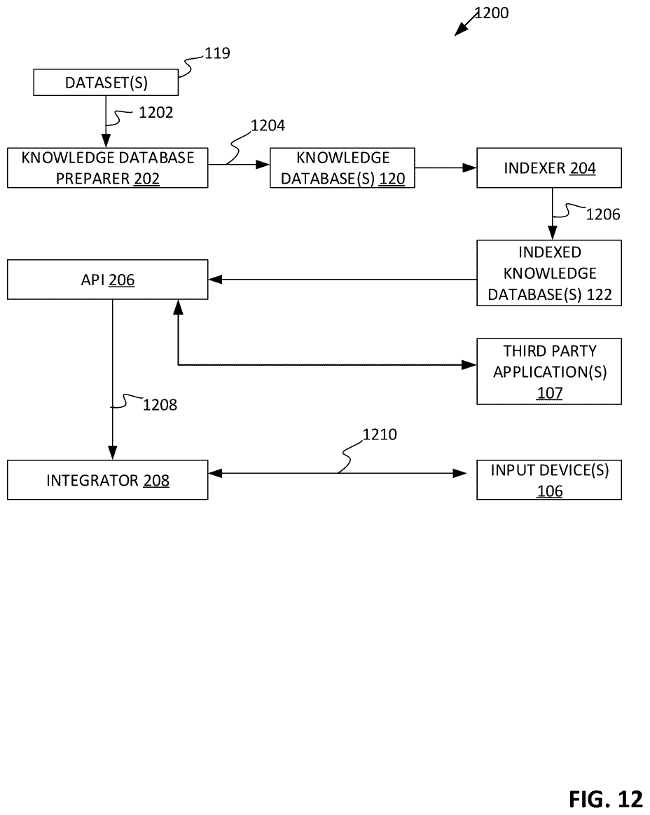

FIG. 12 illustrates a flow diagram of an example, non-limiting computer-implemented method 1200 that can be implemented to configure one or more virtual assistants 116 for responding to user inquiries in accordance with one or more embodiments described herein.

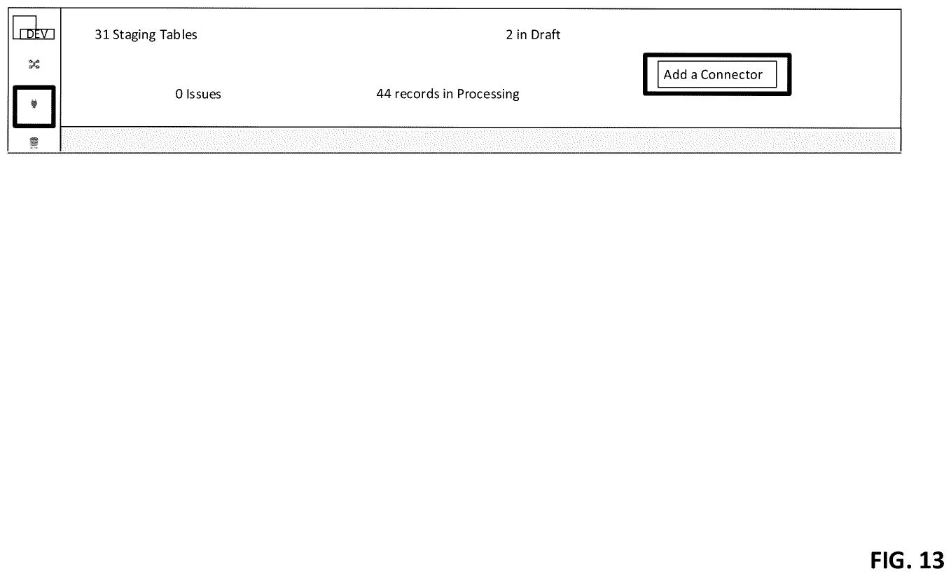

At 1202, the computer-implemented method 1200 can comprise retrieving (e.g., via one or more input devices 106) one or more datasets 119. For example, the one or more datasets 119 can be pre-processed and/or transformed into one or more defined file formats (e.g., a CSV file). Further, the one or more datasets 119 can be uploaded to the system 100 (e.g., via the one or more input devices 106) to facilitate the formation of one or more knowledge databases 120. For example, FIG. 13 depicts an example user interface 1300 that can be employed by a developer (e.g., via the one or more input devices 106) to upload data.

For example, with regard to the example user interface 1300, the developer can click the connector icon 1302 on the left side menu, then the “Add a Connector” 1304 (e.g., as shown in FIG. 13) to upload the input data (e.g., from which the content attributes can be sourced). The system 100 (e.g., via the virtual assistant 116 and/or the one or more input devices 106) can present a sequence of user displays to fill in information about the new connector.

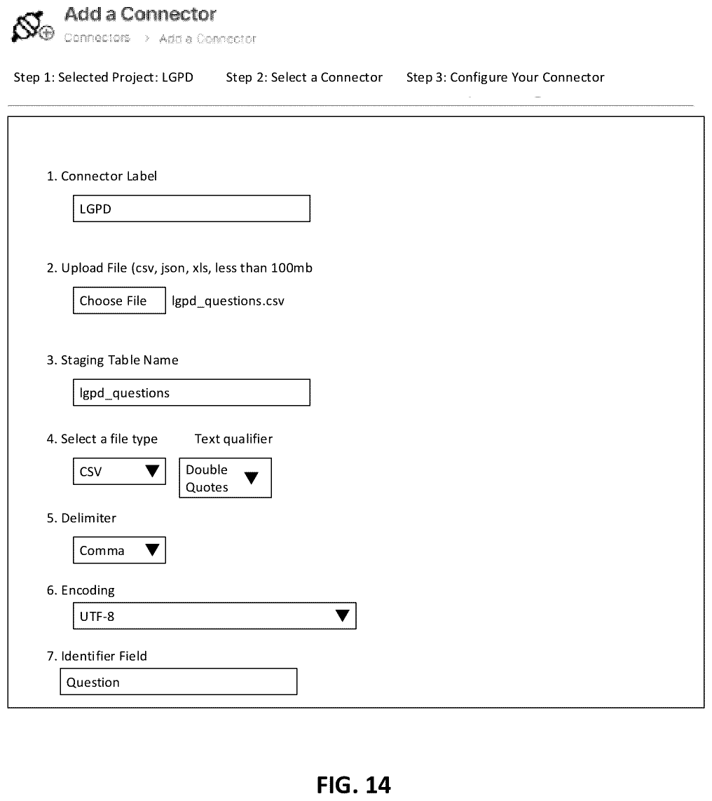

At 1204, the computer-implemented method 1200 can comprise preparing (e.g., via knowledge database preparer 202), via the system 100 operably coupled to one or more processing units 108, one or more knowledge databases 120 based on the input data entered into the system at 1202. In accordance with various embodiments described herein, the knowledge database preparer 202 can generate one or more knowledge databases 120 to organize the input data in a manner that facilitates searches by the virtual assistant 116. For example, the system 100 can utilize one or more user interfaces (e.g., presented via the one or more input devices 106) to prompt the developer for information regarding the connector (e.g., regarding the input data) to prepare the knowledge database 120. For instance, the developer can designate a new project name for the added connected (e.g., “LGPD” in the example illustrated in FIG. 14). FIG. 14 depicts an example user interface 1400 that the developer can engage to define one or more parameters (e.g., field titles) for preparing the one or more knowledge databases 120.

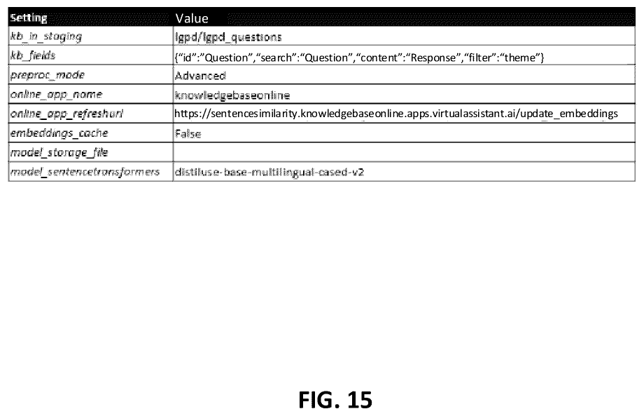

At 1206, the computer-implemented method 1200 can comprise indexing (e.g., via indexer 204) the knowledge database 120. In one or more embodiments, the indexing can be done by semantic characteristics of the text, using deep learning models 124. For instance, FIG. 15 depicts example configuration settings that can be employed by the indexer 204 to perform the indexing at 1206 in accordance with the various embodiments described herein. For example, “kb_in_staging” can indicate the connector (e.g., “lgpd”) and staging (e.g., “lgpd_questions”) that can be utilized from the same environment previously created. Further, “kb_fields” can be indicative of which table attributes of the input data will be used as identifier, search, content, and filter. Additionally, “preproc_mode” can utilize advanced pre-processing, which can include encoding standardization, removal of special characters, conversion to lowercase, and removal of stopwords in accordance with various embodiments described herein. Further, “online_app_name” can delineate the publication of a template in an online application. Moreover, “online_app_refreshurl” can refresh the address from the same application defined above. Also, “embeddings_cahe” can define whether a cache is utilized (e.g., where a small knowledge database 120 is utilized, there may be no significant gain with the use of cache, thus the value “False” can be utilized. “Model_storage_file” can be left empty or populated with a fine-tuning model (e.g., selected from a plurality of models 124). In one or more embodiments, “model_sentencetransformers” can be populated with a default pre-trained model 124. With the settings defined, the indexer 204 can execute the various functions described herein, where a “knowledgebase_encoded” file can be made available on the “storage” tab of a destination application (e.g., as shown in FIG. 15).

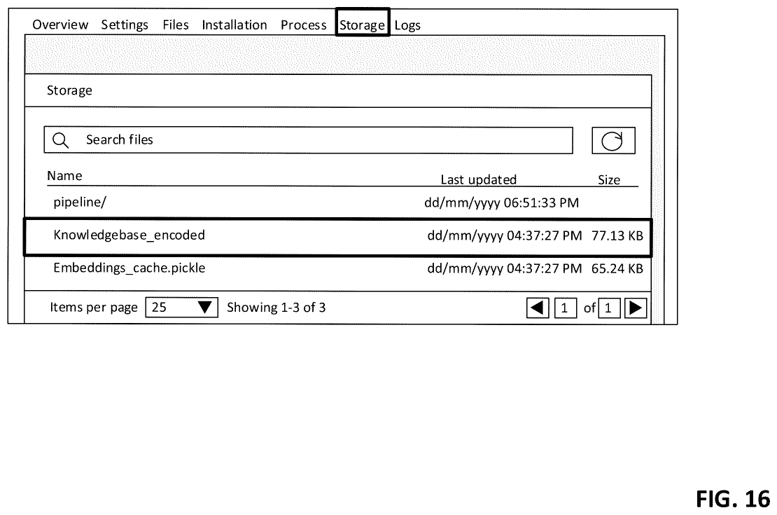

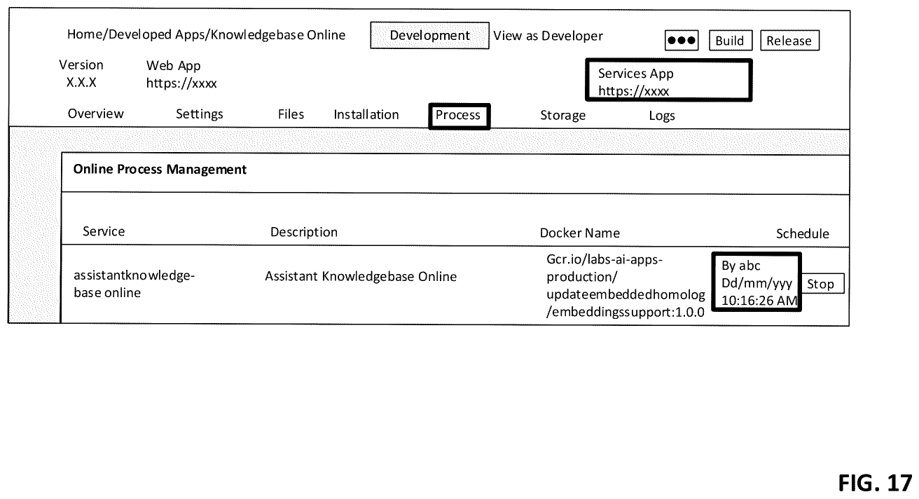

At 1208, the computer-implemented method 1200 can comprise searching (e.g., via API 206), by the system 100, the indexed attributes of the prepared knowledge database 120 for one or more articles responsive to a user's inquiry with the virtual assistant 116. In one or more embodiments, the query interface to the knowledge database 120 can be decoupled from the graphical user interface (e.g., of the one or more input device 106), which allows its use both by the virtual assistant 116 itself and by other applications. Further, API settings can be explored in the REST API for the searches section. For example, in one or more embodiments, the indexer 204 can, at the end of execution, submit a request to the address given in the “online_app_refreshurl” parameter. The purpose is to notify the online app that there is a new version of the knowledge database 120 available, causing it to update the base loaded in memory. If the online application is down, the batch can fail, but the knowledge database 120 file will already be written in the target application; thereby, there is no need to rerun the online application. FIG. 16 illustrates an example user interface 1600 that can be utilized to engage the searching at 1208. For example, to launch the API 206, the developer can select the knowledgebase_online application, select the “Process” tab, and then the “Run” button (e.g., as shown in FIG. 16). In various embodiments, the API 206 can further communicate with one or more third party applications 107 to facilitate the search, engage in one or more machine learning models, retrieve additional source knowledge, a combination thereof, and/or the like.

At 1210, the computer-implemented method 1200 can comprise integrating (e.g., via integrator 208) the knowledge database 120 and/or API 206 with a conversation flow with a user. At this point the query data can be consolidated, submitted to the query API 206 and the results can be organized and presented. In accordance with various embodiments described herein, the integration at 1210 can take place through the fulfillment functionality (e.g., having a configuration that is flexible through python coding). In one or more embodiments, the fulfillment functionality allows any logic along the conversation flow to be implemented through computer code (e.g., via Python language and/or the like). The current state of the conversational flow is stored on the parameters variable, based on the parameters and the history of interactions, the user has conducted through different conversation paths with the virtual assistant 116.

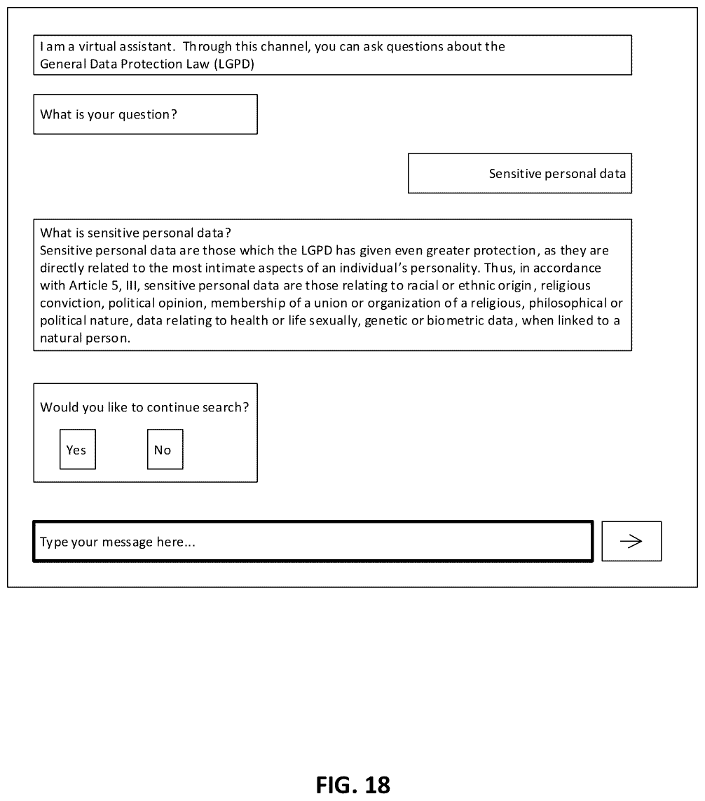

In the example described above, the knowledge database 120 can comprise 35 questions, where a filter is not required by the survey; thereby contributing to one less iteration in the flow and simplification of the fulfillment functionality. For larger knowledge databases 120, filters can be applied, as the greater the scope of the search, the greater the chances that the content returned will not be responsive to the user's inquiry. As described herein, FIG. 10 illustrates an example fulfillment code 1002, which can characterize a conversation flow that can be called right after a welcome message sent to the user. The example fulfillment code 1002 shown in FIG. 10 can assume at least two additional intentions: search again and default fallback. The first is used to deal with the possibility of the user performing new queries without the need to restart the flow, and the second is used in case the search fails. The result of the implemented flow can be seen in FIG. 18.

In one or more embodiments, responding to user inquiries can be addressed through pre-trained baseline models 124 for performing the article search and/or similarity comparison. Alternatively, in some embodiments machine learning models 124 trained on domain specific training datasets can be employed when the amount of data composing the search space exceeds a predefined threshold.

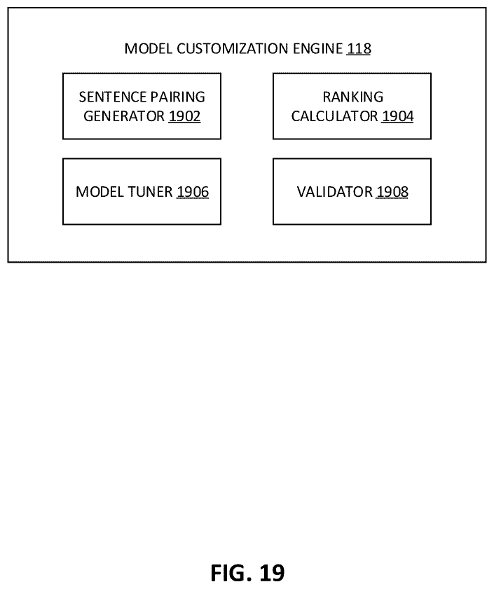

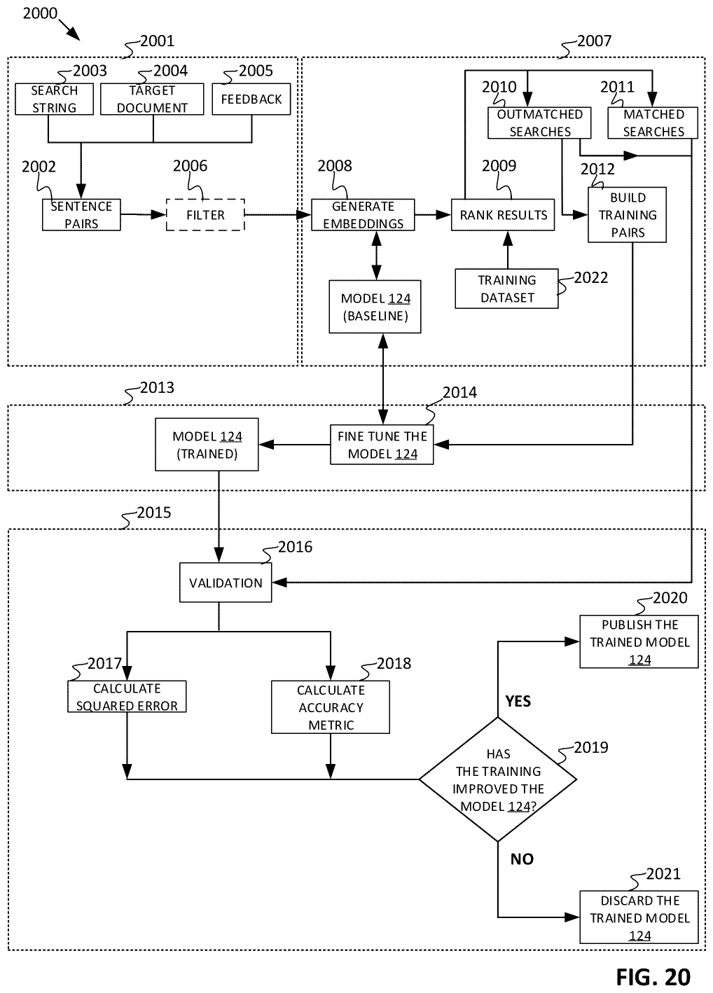

In various embodiments, the model customization engine 118 can summarize each of the articles contents by a common set of features, which can be represented by the latent space resulting from an encoder model 124. As shown in FIG. 19, the model customization engine 118 can comprise sentence pairing generator 1902, ranking calculator 1904, model tuner 1906, and/or validator 1908 in accordance with one or more embodiments described herein. Further, FIG. 20 illustrates a flow diagram of an example, non-limiting computer-implemented method 2000 that can be implemented by the model customization engine 118 and/or associate components. In various embodiments, the model customization engine 118 can employ computer-implemented method 2000 in ranking one or more articles and/or performing a sentence-to-sentence (“STS”) natural language processing (“NLP”) training procedure.

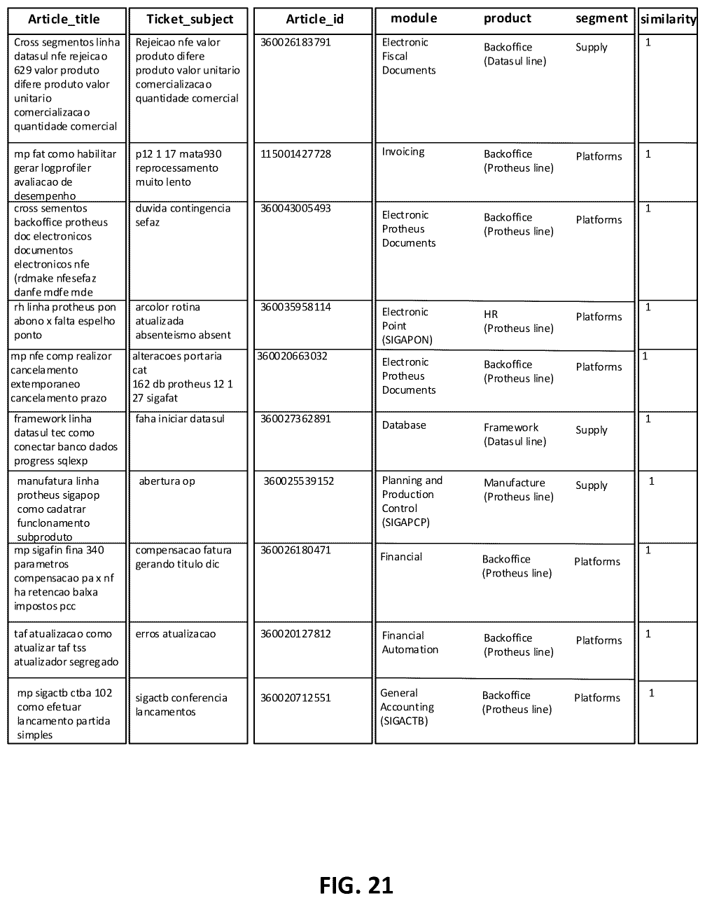

At 2001 (e.g., as delineated by the dotted lines), the computer-implemented method 2000 can comprise preparing (e.g., via sentence pairing generator 1902) one or more sentence pairs 2002 from a training dataset (e.g., at least partially exemplified in FIG. 21) that includes search string 2003, target document 2004, and/or feedback 2005. For example, sentence pairs 2001 can be generated for pairings of search strings 2003 and target document 2004 of known similarity. In one or more embodiments, the sentence pairs 2002 can be optionally (e.g., as delineated by the dashed lines) filtered at 2006 based on established feedback 2005 characterizing the pairing. For example, an amount of similarity between the search string 2003 and the target document 2004 (e.g., representing a content attribute) can be characterized by feedback 2005, which can generated by a supervised evaluation. For instance, developer feedback 2005 can be utilized to generate the sentence pairs (e.g., to facilitate the identification of similar and/or dissimilar pairings).

At 2007 (e.g., as delineated by the dotted lines), the computer-implemented method 2000 can comprise calculating (e.g., via ranking calculator 1904) one or more target document rankings based on one or more baseline models 124. For instance, one or more baseline models 124 (e.g., natural language processing models) can be employed by the calculation component 1904 to generate embeddings at 2008 and rank results at 2009. For instance, the one or more models 124 can be utilized to rank the target documents in order of responsiveness to the search string based on the sentence pairs. Based on the ranking, outmatched searches 2010 and matches searches 2011 can be identified. As described further herein, the outmatched searches including a target document other than the expected target document (e.g., including a non-responsive document to the search string) and that are ranked higher than a search result that includes the expected target document. For example, where the top search results are defined as the top three highest ranked search results, and the sentence pairing that includes the expected, most responsive target document is ranked third; the first and second ranked results can be outmatches searches.

Additionally, the outmatched searches 2010 can be utilized to build training pairs at 2012 to facilitate fine tuning of the baseline model 124. As described further herein, the training pairs built at 2012 can include positive pairing samples and/or negative pairing samples. The positive pairing samples can include a pairing of the search string and the expected target document (e.g., the target document responsive to the search string), such as one of the matched searches. Further, the similarity score of the positive pairing sample can be artificially inflated (e.g., positively weighted) to characterize a higher amount of similarity than previously calculated via the model 124. The negative pairing samples can include the actual results from the model 124 (e.g., the outmatched searches 2010). For instance, the actual results can include the search string paired with less responsive target documents than the expected target document (e.g., such as the outmatched searches 2010). Additionally, the similarity score of the negative pairing can be artificially deflated (e.g., negatively weighted) to characterize a lower amount of similarity than previously calculated via the model 124.

At 2013, the computer-implemented method 2000 can comprise fine tuning (e.g., via model tuner 1906) one or more models 124 (e.g., machine learning models) using the sentence pairings and a loss function regarding the similarity scores (e.g., a cosine loss function based on the similarity scores). For example, at 2014 the training pairs (e.g., including one or more positive pair samples and negative pair samples) can be used to adjust one or more parameters of the baseline model 124 utilized to perform the ranking at 2009. For instance, the fine tuning process can adjust the deep neural network (“DNN”) weights from the pre-training (e.g., employed by the baseline model 124) by comparing the similarity from the training pairs and adjust the weight values of one or more parameters according. Thereby, the fine tuning the model 124 at 2014 can include adjusting one or more parameter weight values based on the inflated similarity scores of the positive pair samples and the deflated similarity scores of the negative pair samples. As such, the tuning process can result in a trained model 124 that can more accurately search for responsive documents (e.g., response articles in a knowledge database 120) in the context of the given domain of the training dataset.

At 2015, the computer-implemented method 2000 can validate (e.g., validator 1908) the trained (e.g., fine-tuned model 124) to determine whether to implement or discard the trained model 124. For example, the outmatched searches 2010 and the matched searches 2011 can be analyzed by the trained model 124 during a training validation process at 2016. As shown in FIG. 20, the results of the trained model 124 can be evaluated by employing one or more loss functions (e.g., a squared error function, such as mean squared error and/or the like) at 2017 and/or accuracy metrics (e.g., mean absolute error and/or the like) at 2018. Based on the evaluations metrics computed at 2017 and/or 2018, the validator 1908 can determine at 2019 whether the fine tuning of the one or more model parameters has improved the efficiency and/or accuracy of the model 124. For example, the evaluation metrics computed at 2017 and 2018 can be compared to one or more evaluation metrics computed with regard to the rank results of the pre-trained model 124 (e.g., the baseline model 124) to identify any improvements in the metrics. Where the metrics have improved, train model 124 can be published at 2020 and employed by the virtual assistant 116 to search the one or more indexed knowledge databases 122 and/or answer user inquiries.

For example, the model customization engine 118 can utilize the computer-implemented method 2000 to: (i) stipulate a similarity value for training sentence pairs; and (ii) choose sentence samples that lead to improved fine tuning procedures. With regards to (i), simply using a value designation of 1 to denote similar pairs and a value designation of 0 for dissimilar pairs has shown poor results on fine tuning procedures in conventional methodologies. Thus, a better sense of similarity between pairs, following a fuzzy logic, can be implemented. With regards to (ii), a relevant consideration includes whether it is worth making adjustments on the model weights given the current level of similarity assigned by the model. This point is closely related to the catastrophic forgetting problem; where the more intensive the adjustment on the weights, the smaller the chance for convergence during training.

In various embodiments, the model customization engine 118 can submit each sentence pair to a ranking process, the same way as it would be performed on the final task, and verify whether the expected article is returned. Sentence pairs where the expected article is returned within the top ranking results (e.g., within ranking through 1 to 3) can be discarded from training set. Since the baseline model 124 already performs well for those cases, the model customization engine 118 can avoid unnecessary weights adjustments (e.g., thereby employing a training protocol referred to herein as “training on errors”).

As described herein, the model customization engine 118 can utilize the outmatched sentence pairs for training as follows. A search string and an expected target document can be joined in new pairing, forming a positive pair sample. The similarity coefficient (e.g., the similarity score) attributed to the positive pair sample can be the similarity retrieved from the baseline model 124, updated with a positive bump. An example is given below, with a positive bump (e.g., inflation) factor of 10%:

search = ‘depalletization’
target = ‘is it possible to perform depalletization’
similarity = 0.53
target similarity = 0.53 * 1.1 = 0.58

Each of the target documents returned with a higher ranking than the expected target document can be used as a negative pair sample. The negative pair samples can then be formed the same way as the positive, but with a negative bump (e.g., deflation) factor. For example:

search = ‘rejection 629’
target = ‘rejection 692’
similarity = 0.83
target similarity = 0.83 * 0.9 = 0.74

The bump applied to the original similarity composes a technique referred to herein as “gentle domain adaptation,” which can preserve the original model (e.g., baseline model 124) weights as much as possible, avoiding aggressive adjustments leading to unstable training. The choice for the bump factor depends on factors such as data quality (e.g., how accurate the samples reflects the reality, or how much noise is generated), baseline model performance, fine tuning epochs, a combination thereof, and/or the like.

In various embodiments, the sentence pairing generator 1902 can perform one or more of the following features. The model customization engine 118 can assume that there is enough data to form sentence pairs 2002 between search strings 2003 and target documents 2004. In various embodiments, search strings 2003 can be ticket titles, chatbot messages and so forth. The target documents 2004, can be represented by a selected field, like title, summary, question etc. Additionally, the model customization engine 118 can assume that the interactions are evaluated by a feedback value 2005, stating whether or not the recommended target document 2004 helped on the problem described by the search string 2003.

FIG. 21 depicts an example that utilizes the field “ticket subject” as the search string 2003 (e.g., presented in Portuguese given its association with a Portuguese target document), “article_title” (e.g., examples of Portuguese publications) to represent the target document 2004, and “similarity” as the feedback value 2005. The “similarity” field can be pre-parsed and/or converted so that a 1 and a 0 represent a positive and negative feedback 2005, respectively. These three fields are already enough to perform traditional training on the baseline model. Various embodiments described herein, train the model 124 on the cases where it fails. To facilitate the training, the sentence pairing generator 1902 can perform a ranking (just like the final task) and retrieve the pairs where the search doesn't return the expected article as the first result (or top 3 for more freedom).

The field “article id” can be a unique identifier (e.g., an identifier attribute) for the target document (e.g., the content attribute and/or search attribute of an article), as “article_title” may be repeated, which can be used to verify the ranking for the document according to the search. The fields “module,” “product,” and “segment” can be used as filtering criteria (e.g., filter attributes). In one or more embodiments, the search can occur within the records of the training dataset 2022 corresponding to the filter fields. The training dataset 2022 can comprise, for example, thousands of documents in total, but the size of the search space for the queries can be restricted by the filter fields (e.g., restricted by the filter attributes).

In various embodiments, the ranking calculator 1904 can perform one or more of the following features. In one or more embodiments, the ranking calculator 1904 can facilitate the correct selection of the training data to improve the quality of the model 124. For example, the ranking calculator 1904 can filter out sentence pairs where the feedback is negative, as these samples can result harm to the training process (e.g., possibly because they don't represent hard samples to the model's task). Positive feedback, however, explicitly states user's expectations were met.

Further, the ranking calculator 1904 can perform the final task (document ranking), using the baseline model 124, and can also discard the records where the model correctly predicts the expected article. For example, pre-trained weights may not be worth changing if the model 124 is already performing as expected.

In one or more embodiments, the positive pair samples and negative pair samples can be produced as the follows. The positive pair samples can be produced using the sentence pair 2002 that includes the search and the expected document string (which has not been returned). Negative pair samples can be produced by taking the top N number of returned articles, retrieving their representation strings and using them as negative samples together with the search. The higher the N, the more negative samples, where using N=1 already proved to be good enough.

In various embodiments, the one or more processing units 108 can comprise any commercially available processor. For example, the one or more processing units 108 can be a general purpose processor, an application-specific system processor (“ASSIP”), an application-specific instruction set processor (“ASIPs”), or a multiprocessor. For instance, the one or more processing units 108 can comprise a microcontroller, microprocessor, a central processing unit, and/or an embedded processor. In one or more embodiments, the one or more processing units 108 can include electronic circuitry, such as: programmable logic circuitry, field-programmable gate arrays (“FPGA”), programmable logic arrays (“PLA”), an integrated circuit (“IC”), and/or the like.

The one or more computer readable storage media 110 can include, but are not limited to: an electronic storage device, a magnetic storage device, an optical storage device, an electromagnetic storage device, a semiconductor storage device, a combination thereof, and/or the like. For example, the one or more computer readable storage media 110 can comprise: a portable computer diskette, a hard disk, a random access memory (“RAM”) unit, a read-only memory (“ROM”) unit, an erasable programmable read-only memory (“EPROM”) unit, a CD-ROM, a DVD, Blu-ray disc, a memory stick, a combination thereof, and/or the like. The computer readable storage media 110 can employ transitory or non-transitory signals. In one or more embodiments the computer readable storage media 110 can be tangible and/or non-transitory. In various embodiments, the one or more computer readable storage media 110 can store the one or more computer executable components 114 and/or one or more other software applications, such as: a basic input/output system (“BIOS”), an operating system, program modules, executable packages of software, and/or the like.

One or more of the computer executable components 114 described herein can be shared between multiple computing devices 102 comprised within the system 100 via the one or more networks 104. The one or more networks 104 can comprise one or more wired and/or wireless networks, including, but not limited to: a cellular network, a wide area network (“WAN”), a local area network (“LAN”), a combination thereof, and/or the like. One or more wireless technologies that can be comprised within the one or more networks 104 can include, but are not limited to: wireless fidelity (“Wi-Fi”), a WiMAX network, a wireless LAN (“WLAN”) network, BLUETOOTH® technology, a combination thereof, and/or the like. For instance, the one or more networks 104 can include the Internet and/or the Internet of Things (“IoT”). In various embodiments, the one or more networks 104 can comprise one or more transmission lines (e.g., copper, optical, or wireless transmission lines), routers, gateway computers, and/or servers. Further, the one or more computing devices 102 can comprise one or more network adapters and/or interfaces (not shown) to facilitate communications via the one or more networks 104.

In various embodiments, the one or more input devices 106 can be employed to enter data and/or commands into the system 100. Example data that can be entered via the one or more input devices 106 can include dataset 119, which can include reference data for responding to one or more queries by the virtual assistant 116. For instance, the one or more input devices 106 can be employed to initialize and/or control one or more operations of the computing device 102 and/or associate components. In various embodiments, the one or more input devices 106 can comprise and/or display one or more input interfaces (e.g., a user interface) to facilitate entry of data into the system 100. Additionally, in one or more embodiments the one or more input devices 106 can be employed to define one or more system 100 settings, parameters, definitions, preferences, thresholds, and/or the like. Also, in one or more embodiments the one or more input devices 106 can be employed to display one or more outputs from the one or more computing devices 102 and/or query one or more system 100 users. For example, the one or more input devices 106 can send, receive, and/or otherwise share data (e.g., inputs and/or outputs) with the computing device 102 (e.g., via a direct electrical connection and/or the one or more networks 104).

The one or more input devices 106 can comprise one or more computer devices, including, but not limited to: desktop computers, servers, laptop computers, smart phones, smart wearable devices (e.g., smart watches and/or glasses), computer tablets, keyboards, touch pads, mice, augmented reality systems, virtual reality systems, microphones, remote controls (e.g., an infrared or radio frequency remote control), stylus pens, biometric input devices, a combination thereof, and/or the like. Additionally, the one or more input devices 106 can comprise one or more displays that can present one or more outputs generated by, for example, the computing device 102. Example displays can include, but are not limited to: cathode tube display (“CRT”), light emitting diode display (“LED”), electroluminescent display (“ELD”), plasma display panel (“PDP”), liquid crystal display (“LCD”), organic light-emitting diode display (“OLED”), a combination thereof, and/or the like. In various embodiments, the one or more input devices 106 can present one or more outputs of the computing device 102 via an augmented reality environment or a virtual reality environment.

In accordance with the various embodiments described herein, one or more of the computer executable components 114 and/or computer-implemented method features described herein can be loaded onto, and/or executed by, a programmable apparatus (e.g., comprising one or more processing units 108, such as computing device 102). When executed, the computer executable components 114 and/or computer-implemented method features described herein can cause the programmable apparatus to implement one or more of the various functions and/or operations exemplified in the referenced flow diagrams and/or block diagrams.

In one embodiment, computer executable components 114 and/or computer-implemented method features described herein can be loaded onto, and/or executed by, a programmable apparatus such as a cloud-based platform or service. In one example, the platform may be coupled to or integrated with a data platform such as the CAROL platform available from TOTVS Labs, Inc.

In the flow diagrams and/or block diagrams of the Drawings, the various blocks can represent one or more modules, segments, and/or portions of computer readable instructions for implemented one or more logical functions in accordance with the various embodiments described herein. Additionally, the architecture of the system 100 and/or methods described herein is not limited to any sequential order illustrated in the Drawings. For example, two blocks shown in succession can represent functions that can be performed simultaneously. In a further example, blocks can sometimes be performed in a reverse order from the sequence shown in the Drawings. Moreover, in one or more embodiments, one or more of the illustrated blocks can be implemented by special purpose hardware based systems.

As used herein, the term “or” is intended to be inclusive, rather than exclusive. Unless specified otherwise, “X employs A or B” is intended to mean any of the natural incisive permutations. That is, if X employs A; X employs B; or X employs both A and B, the “X employs A or B” is satisfied. Additionally, the articles “a” or “an” should generally be construed to mean, unless otherwise specified, “one or more” of the respective noun. As used herein, the terms “example” and/or “exemplary” are utilized to delineate one or more features as an example, instance, or illustration. The subject matter described herein is not limited by such examples. Additionally, any aspects, features, and/or designs described herein as an “example” or as “exemplary” are not necessarily intended to be construed as preferred or advantageous. Likewise, any aspects, features, and/or designs described herein as an “example” or as “exemplary” is not meant to preclude equivalent embodiments (e.g., features, structures, and/or methodologies) known to one of ordinary skill in the art.

Understanding that is not possible to describe each and every conceivable combination of the various features (e.g., components, products, and/or methods) described herein, one of ordinary skill in the art can recognize that many further combinations and permutations of the various embodiments described herein are possible and envisaged. Furthermore, as used herein, the terms “includes,” “has,” “possesses,” and/or the like are intended to be inclusive in a manner similar to the term “comprising” as interpreted when employed as a transitional word in a claim.

### ADDITIONAL EMBODIMENTS

Embodiment A: A computer-implemented method for selecting training data comprising: receiving sentence pairs; and ranking results based on data in a knowledge base according to unmatching searches and matching searches; for unmatching search results: building training pairs; outputting positive samples for expected results; outputting negative samples for actual results; and fine tune a pretrained model based on the output positive and negative samples prior to validation; and for matching search results: outputting the matching search results for validation.
Embodiment B: A chatbot system, comprising: memory to store computer executable instructions; and one or more processors, operatively coupled to the memory, that execute the computer executable instructions to implement: a virtual assistant configured to identify content data from a knowledge database that is related to query based on one or more semantic similarities derived between text of the query and the content data.
Embodiment C: The chatbot system of embodiment B, wherein the virtual assistant comprises: a knowledge base component configured to prepare the knowledge base based on best practices regarding database preparation for search and field roles; an indexing component configured to index, via a deep learning model, the knowledge base based on semantic characteristics of text data comprised within the knowledge base; an application programing interface component configured to search an application program interface; and an integration component configured to execute fulfillment code to generate a customizable answer to the query based on the identified content data.

What is claimed is:

1. A computer-implemented method for training a machine learning model for sentence pair matching in natural language processing, the computer-implemented method comprising:
preparing sentence pairs from a training dataset, wherein each sentence pair comprises a pairing of a search string and a target document from the training dataset;
ranking the sentence pairs based on an amount of similarity between the search string and the target document;
identifying an outmatched sentence pair, wherein the target document of the outmatched sentence pair is a non-responsive document to the search string; and
utilizing the outmatched sentence pair to tune a parameter of a natural language processing model to generate a trained model.

2. The computer-implemented method of claim 1, further comprising:
generating training pairs to tune the parameter of the natural language processing model, wherein the training pairs comprise a positive data sample and a negative data sample.

3. The computer-implemented method of claim 2, wherein the positive pairing sample is a first sentence pair comprising the search string and a responsive document, wherein the positive pairing sample is characterized by an artificially inflated similarity score, wherein the negative pairing sample is a second sentence pair comprising the search string and the non-responsive document, and wherein the negative pairing sample is characterized by an artificially deflated similarity score.

4. The computer-implemented method of claim 3, wherein the second sentence pairing ranked higher than the first sentence pairing as a result of the ranking.

5. The computer-implemented method of claim 3, wherein the natural language processing model is executed to perform the ranking of the sentence pairs, and wherein the ranking generates a first initial similarity score for the first sentence pair and a second initial similarity score for the second sentence pair.

6. The computer-implemented method of claim 4, further comprising:
generating the artificially inflated similarity score by increasing the first initial similarity score by a first defined amount; and
generating the artificially deflated similarity score by decreasing the second initial similarity score by a second defined amount.

7. The computer-implemented method of claim 6, further comprising:
discarding from the training dataset expected result sentence pairs to generate a revised training dataset, wherein expected result sentence pairs are the sentence pairs positioned in a predefined top portion of the ranking and comprise one or more responsive documents to the search string.

8. The computer-implemented method of claim 7, further comprising:
tuning the trained model using the revised training data.

9. The computer-implemented method of claim 6, further comprising:
validating the outmatched sentence pair and a matched sentence pair with the trained model to evaluate an accuracy metric characterizing the trained model's ability to identify target documents that are responsive to the search string.

10. A chatbot system, comprising:
memory to store computer executable instructions; and
one or more processors, operatively coupled to the memory, that execute the computer executable instructions to implement:
a virtual assistant that identifies content data from a knowledge database that is related to query based on a similarity score that characterizes a sentence pairing that includes text of the query and an article attribute, wherein the article attribute is at least one of a content attribute or a search attribute.

11. The chatbot system of claim 10, wherein the virtual assistant comprises:
a knowledge database preparer that generates the knowledge database to include a plurality of articles that include the content data, the search attribute, and the filter attribute; and
an indexer configured to index the knowledge base based on semantic characteristics of text data comprised within the knowledge base.

12. The chatbot system of claim 11, further comprising:
an application program interface that executes a machine learning model to search the knowledge database for an article comprising the content data that is related to the query by a defined similarity score threshold.

13. The chatbot system of claim 12, further comprising:
an integrator that executes a fulfillment code to generate a customizable response to the query based on the identified content data.

14. A computer program product for training a natural language processing model for search a knowledge database for a response to a query, the computer program product comprising a computer readable storage medium having computer executable instructions embodied therewith, the computer executable instructions executable by one or more processors to cause the one or more processors to:
prepare sentence pairs from a training dataset, where each sentence pair comprises a pairing of a search string and a target document from the training dataset;
rank the sentence pairs based on an amount of similarity between the search string and the target document;
identify an outmatched sentence pair, wherein the target document of the outmatched sentence pair is a non-responsive document to the search string; and
utilize the outmatched sentence pair to tune a parameter of a natural language processing model to generate a trained model.

15. The computer program product of claim 14, wherein the computer executable instructions further cause the one or more processors to:
generate training pairs to tune the parameter of the natural language processing model, wherein the training pairs comprise a positive data sample and a negative data sample, wherein the positive pairing sample is a first sentence pair comprising the search string and a responsive document, wherein the positive pairing sample is characterized by an artificially inflated similarity score, wherein the negative pairing sample is a second sentence pair comprising the search string and the non-responsive document, and wherein the negative pairing sample is characterized by an artificially deflated similarity score.

16. The computer program product of claim 15, wherein the second sentence pairing ranked higher than the first sentence pairing as a result of the ranking.

17. The computer program product of claim 15, wherein the natural language processing model is executed to perform the ranking of the sentence pairs, and wherein the ranking generates a first initial similarity score for the first sentence pair and a second initial similarity score for the second sentence pair.

18. The computer program product of claim 17, wherein the computer executable instructions further cause the one or more processors to:
generate the artificially inflated similarity score by increasing the first initial similarity score by a first defined amount; and
generate the artificially deflated similarity score by decreasing the second initial similarity score by a second defined amount.

19. The computer program product of claim 18, wherein the computer executable instructions further cause the one or more processors to:
discard from the training dataset expected result sentence pairs to generate a revised training dataset, wherein expected result sentence pairs are the sentence pairs positioned in a predefined top portion of the ranking and comprise one or more responsive documents to the search string.

20. The computer program product of claim 19, wherein the computer executable instructions further cause the one or more processors to:
validate the outmatched sentence pair and a matched sentence pair with the trained model to evaluate an accuracy metric characterizing the trained model's ability to identify target documents that are responsive to the search string.
